(19) United States
(12) Patent Application Publication
(10) Pub. No.: US 2016/0086119 A1
(43) Pub. Date: Mar. 24, 2016

(54) EQUAL DISTRIBUTION OF WORKLOAD IN A WAREHOUSE

(71) Applicants: Markus Puchta, St. Leon-Rot (DE); Sebastian Wolf, Karlsruhe (DE); Tobias Adler, Viernheim (DE)

(72) Inventors: Markus Puchta, St. Leon-Rot (DE); Sebastian Wolf, Karlsruhe (DE); Tobias Adler, Viernheim (DE)

(21) Appl. No.: 14/493,104

(22) Filed: Sep. 22, 2014

(51) Int. Cl. G06Q 10/06; G06F 17/30

(52) U.S. Cl. CPC G06Q 10/06316; G06F 17/30386

(57) ABSTRACT

Systems, methods, and non-transitory computer-readable mediums having program instructions thereon, provide for equally distributing workloads in a warehouse. In an embodiment, the workloads are distributed to the resources/employees so that there are no overloads at certain points in time as well as no idle times. In an embodiment, the equal distribution of the workload can be defined for different activity areas corresponding to a single team. In an embodiment, the equal distribution of the workload can be defined subject to a variable available capacity (i.e., the available capacity is not constant over time but has some breaks/reduced capacity in between, e.g., lunch break). Further, in an embodiment, the distribution of the workload can be defined subject to warehouse area constraints (e.g., size of the aisles).

### FIELD

The present disclosure relates generally to a method of developing a planning function to equally distribute workloads in a warehouse.

### BRIEF DESCRIPTION OF THE DRAWINGS

The accompanying drawings illustrate the various embodiments and, together with the description, further serve to explain the principles of the embodiments and to enable one skilled in the pertinent art to make and use the embodiments.

FIG. 1A illustrates an embodiment of an equal distribution plan for a workload.

FIG. 1B illustrates another embodiment of the equal distribution plan for the workload.

FIG. 1C illustrates an embodiment of a minimum constraint of the workload.

FIG. 1D illustrates another embodiment of the minimum constraint of the workload.

FIG. 1E illustrates an embodiment of an equal distribution plan in conjunction with the minimum constraints of the workload.

FIG. 1F illustrates an embodiment of a maximum constraint of the workload.

FIG. 1G illustrates another embodiment of the maximum constraint of the workload.

FIG. 1H illustrates an embodiment of an equal distribution plan in conjunction with the maximum constraints of the workload.

FIG. 1I illustrates another embodiment of a maximum constraint of the workload.

FIG. 1J illustrates another embodiment of the maximum constraint of the workload.

FIG. 2A illustrates an embodiment of a method for conforming the equal distribution plan to the minimum and maximum constraints of the warehouse workload.

FIG. 2B illustrates an embodiment of an equal distribution plan defined within the minimum and maximum constraints of the warehouse workload.

FIG. 2C illustrates embodiments of (1) equal distribution plans in violation of the minimum and maximum constraints of the warehouse workload and (2) equal distribution plans conformed to the minimum and maximum constraints of the warehouse workload with the method of FIG. 2A.

FIG. 2D illustrates another embodiment of (1) an equal distribution plan in violation of the minimum and maximum constraints of the warehouse workload and (2) an equal distribution plan conformed to the minimum and maximum constraints of the warehouse workload with the method of FIG. 2A.

FIG. 3A illustrates an embodiment of a method of distributing a planned workload from a team level to the warehouse area levels.

FIG. 3B illustrates an embodiment of a method for determining whether the minimum constraint of a warehouse area level can be fulfilled by the equal distribution plan of the team level.

FIG. 3C illustrates an embodiment of a method for determining whether the maximum constraint of a warehouse area level can be fulfilled by the equal distribution plan of the team level.

FIG. 3D illustrates an example of distributing a planned workload from a team level to the warehouse area levels utilizing the method of FIG. 3A.

FIG. 3E illustrates the equal distribution plan, the minimum workload constraint and the maximum workload constraint for the total team workload for the example in FIG. 3D.

FIG. 3F illustrates the equal distribution plans and minimum and maximum workload constraints for workload areas T010 and T020 for the example in FIG. 3D.

FIG. 3G illustrates another example of distributing a planned workload from a team level to the warehouse area levels utilizing the methods of FIGS. 3A, 3B AND 3C.

FIG. 3H illustrates the equal distribution plan, the minimum workload constraint and the maximum workload constraint for the total team workload for the example in FIG. 3G.

FIG. 3I illustrates the equal distribution plans and minimum and maximum workload constraints for workload areas T010 and T020 for the example in FIG. 3G.

FIG. 3J illustrates an example of distributing a planned workload from a team level to the warehouse area levels (with a violation of the minimum constraint) utilizing the methods of FIG. 3A, 3B AND 3C.

FIG. 3K illustrates the equal distribution plan, the minimum workload constraint and the maximum workload constraint for the total team workload for the example in FIG. 3J.

FIG. 3L illustrates the equal distribution plans and minimum and maximum workload constraints for workload areas T010 and T020 for the example in FIG. 3J.

FIG. 4A illustrates an embodiment of a method for conforming the equal distribution plan to the available capacity of resources.

FIG. 4B illustrates embodiments of (1) an equal distribution plan in violation of the available capacity and (2) an equal distribution plan conformed to the available capacity for the warehouse workload with the method of FIG. 4A.

FIG. 4C illustrates embodiments of (1) the available capacity in violation of the minimum constraint curve and (2) the equal distribution plan and minimum constraint curve conformed to the available capacity with the method of FIG. 4A.

FIG. 5 illustrates an embodiment of a system utilizing the methods of the present invention.

FIG. 6A illustrates an embodiment of the interaction between the elements of the system in order to conform the equal distribution plan to the minimum and maximum constraints of the warehouse workload.

FIG. 6B illustrates an embodiment of the interaction between the elements of the system in order to distribute a planned workload from a team level to the warehouse area levels.

FIG. 6C illustrates an embodiment of the interaction between the elements of the system in order to conform the equal distribution plan to the available capacity of resources.

### DETAILED DESCRIPTION

According to an embodiment of the present disclosure, systems, methods, and non-transitory computer-readable mediums having program instructions thereon, provide for equally distributing workloads in a warehouse. A warehouse includes tasks of different types to be performed (e.g. pick a product from a bin, pack several products together in a handling unit). All tasks create a workload. This workload is defined by a needed capacity, a planned duration, an earliest starting time and a latest finishing time. In an embodiment, the needed capacity per workload is one (1) FTE (Full Time Equivalent) (which can be modified as required). In an embodiment, the available capacity is defined by resources and/or employees. In an embodiment, the workloads are distributed to the resources/employees so that there are no overloads at certain points in time as well as no idle times. Further, in an embodiment, the equal distribution of the workload can be defined for different activity areas corresponding to a single team (e.g. Team 1 is responsible for Picking of heavy parts in activity area T010 and T020). Further, in an embodiment, the equal distribution of the workload can be defined subject to a variable available capacity (i.e., the available capacity is not constant over time but has some breaks/reduced capacity in between, e.g., lunch break). Further, in an embodiment, the distribution of the workload can be defined subject to warehouse area constraints (e.g., size of the aisles).

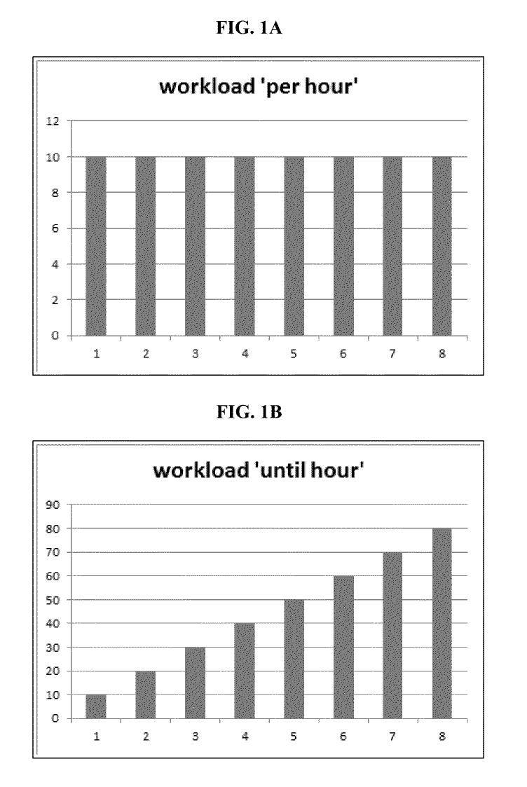

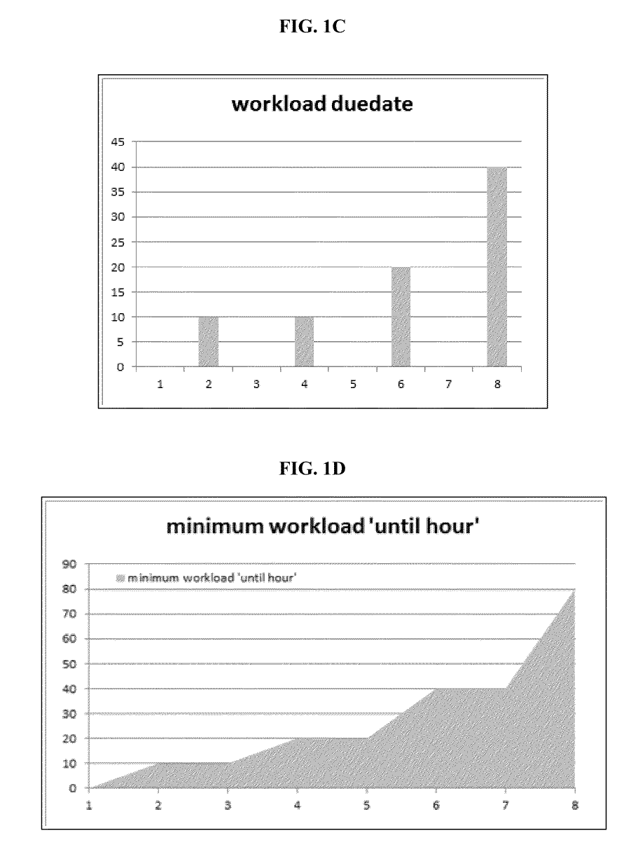

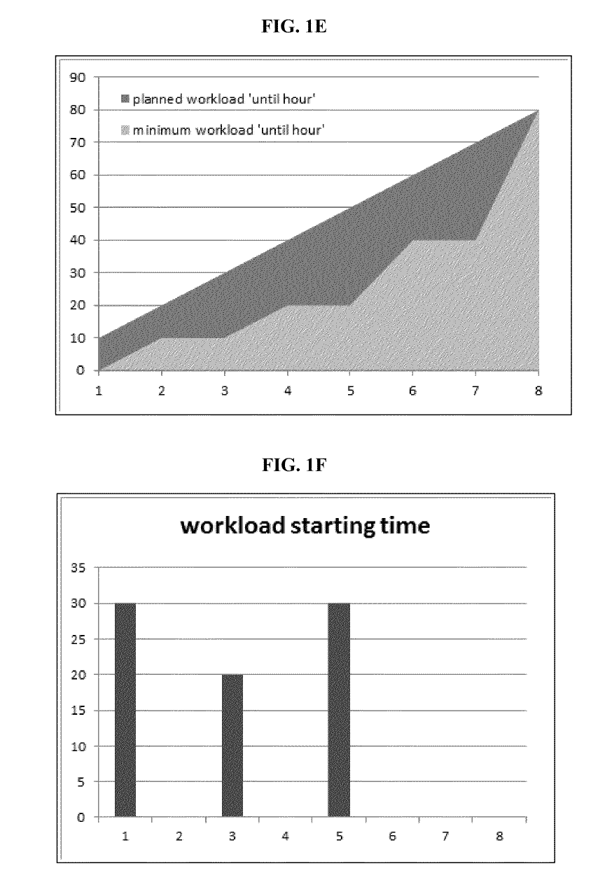

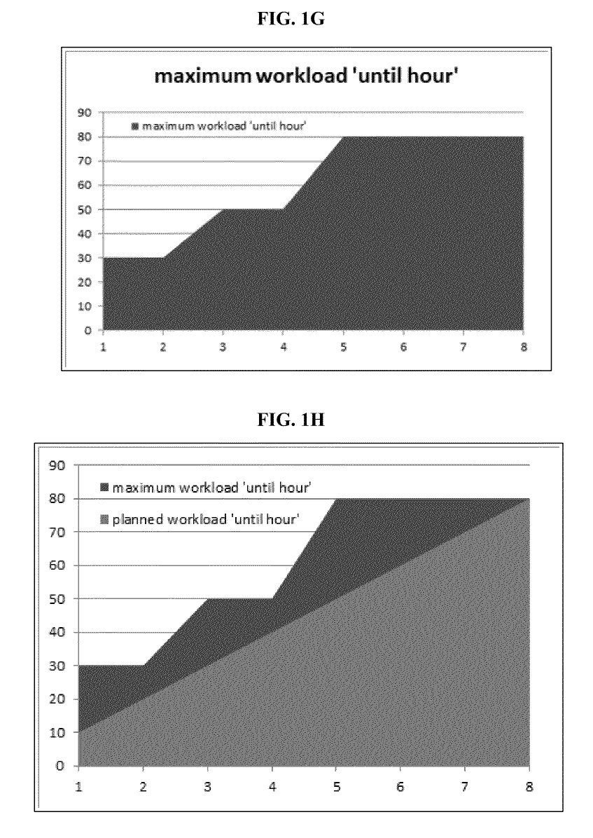

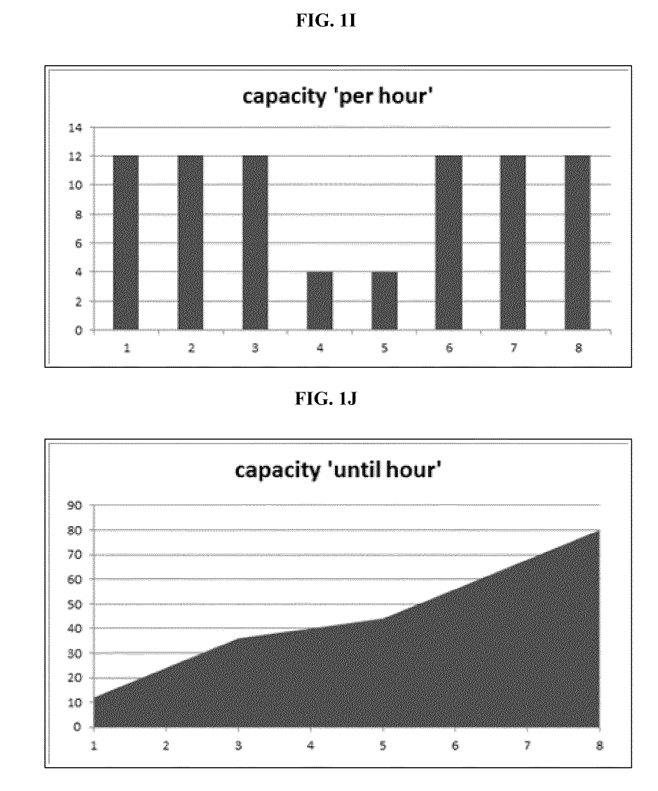

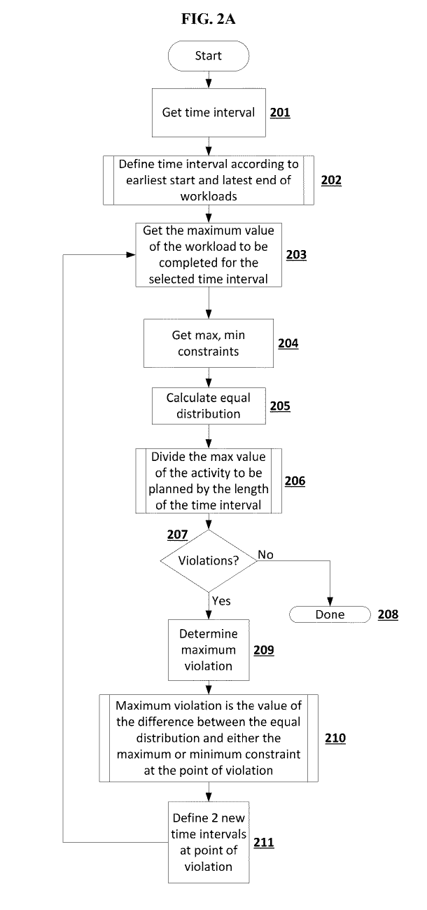

FIG. 1A illustrates an embodiment of an equal distribution plan for a workload. In FIG. 1A, a total workload of 80 kg is distributed over an eight-hour workday. Without any further constraints, assuming a team of ten, one person can handle a workload of 1 kg per hour. Accordingly, 10 kg of workload is planned for each hour of the eight-hour workday. FIG. 1B illustrates another embodiment of the equal distribution plan for the workload. In FIG. 1B, each hour of the day depicts a quantity of the workload to be finalized. In other words, each hour of the workday takes into consideration the workload planned in the hours preceding it. For example, 50 kg of workload will be done at the end of the hour 5.

In an embodiment, in certain warehouses, the workload needs to be performed by a certain point in time because of a “due date” of a corresponding delivery order. In an embodiment, the “due date” defines the latest finishing time for the workloads. In other words, the “due date” corresponds to a minimum constraint for finalizing workload until a certain point in time. In an embodiment, the overall minimum constraint can be determined by sorting the workloads due to their latest finishing time and then summing the value of the workload up for each time interval. FIG. 1C illustrates an embodiment of a minimum constraint of the workload. In FIG. 1C, a total workload of 80 kg needs to be performed in an eight-hour workday. Of the 80 kg, 10 kg needs to be done by the end of hour 2, another 10 kg by the end of hour 4, an additional 20 kg by the end of hour 6 and 40 kg by the end of hour 8. In FIG. 1C, although there are time constraints, assuming a team of ten, one person can handle a workload of 1 kg per hour. Accordingly, 10 kg of workload is planned for each hour of the eight-hour workday. FIG. 1D illustrates another embodiment of the minimum constraint of the workload. FIG. 1D depicts the workload that needs to be done until a certain point in time to fulfill the minimum constraint. For example, 10 kg needs to be done by the end of hour 2, 20 kg needs to be done by the end of hour 4, 40 kg needs to be done by the end of hour 6 and, lastly, 80 kg needs to be done by the end of hour 8. FIG. 1E illustrates an embodiment of an equal distribution plan in conjunction with the minimum constraints of the workload. As depicted by FIG. 1E, a planned distribution of 10 kg per hour conforms to the minimum constraints described above.

In an embodiment, in certain warehouses, the workload can only be started at a certain point in time due to the availability of the stock; thus, defining the earliest starting time for the workloads. The earliest starting time corresponds to a maximum constraint for finalizing the workload until a certain point in time. In an embodiment, the overall maximum constraint can be determined by sorting the workloads due to their earliest starting time and the summing the value of the workload for each time interval. FIG. 1F illustrates an embodiment of a maximum constraint of the workload. In FIG. 1F, a total workload of 80 kg needs to be performed in an eight-hour workday. Of the 80 kg per day, 30 kg can be started in hour 1, another 20 kg can be started at hour 3, and an additional 30 kg from hour 5. Further, although there are time constraints, assuming a team of 10, 1 person can handle a workload of 1 kg per hour. Accordingly, 10 kg of workload is planned for each hour of the eight-hour workday. FIG. 1G illustrates another embodiment of the maximum constraint of the workload. FIG. 1G depicts the greatest amount of workload that can be done at a certain point in time due to the starting times of the workload. For example, at most 30 kg can be done by the end of hour 2, at most 50 kg can be completed by the end of hour 4 and, lastly, 80 kg can be completed by the end of hour 8. FIG. 1H illustrates an embodiment of an equal distribution plan in conjunction with the maximum constraints of the workload. As depicted by FIG. 1H, a planned distribution of 10 kg per hour conforms to the maximum constraints described above.

In an embodiment, the availability of employees/resources also affects the amount of workload to be completed. For example, the employees in a warehouse do not all work at the same time (i.e., they work different shifts) and they may have a break at different times of the day. Further, in addition to full-time employees, part-time employees may also be available to complete a workload. Further, the number of available pack stations also affects the amount of workload to be finalized and completed per hour. Accordingly, the availability of employees/resources may also be considered a maximum constraint. Thus, the available capacity may be defined as a constant number over time or, more complexly, with peaks in between.

FIG. 1I illustrates another embodiment of a maximum constraint of the workload. In FIG. 1I, an average capacity of 10 kg per hour of an eight-hour workday is assumed. However, because there is a possibility of a lunch break in between, there will be more than 10 kg of the workload completed in the morning and afternoon (and, thus, less during the lunch break). FIG. 1J illustrates another embodiment of the maximum constraint of the workload. FIG. 1J depicts the greatest capacity available to complete the workload at a certain point in time. For example, at most 36 kg of workload can be completed by the available capacity by the end of hour 3, at most 44 kg of workload can be completed by the available capacity by the end of hour 5 and, lastly, 80 kg of workload can be completed by the available capacity by the end of hour 8.

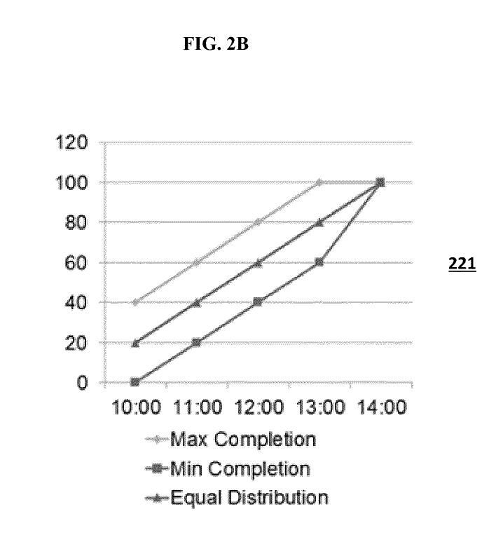

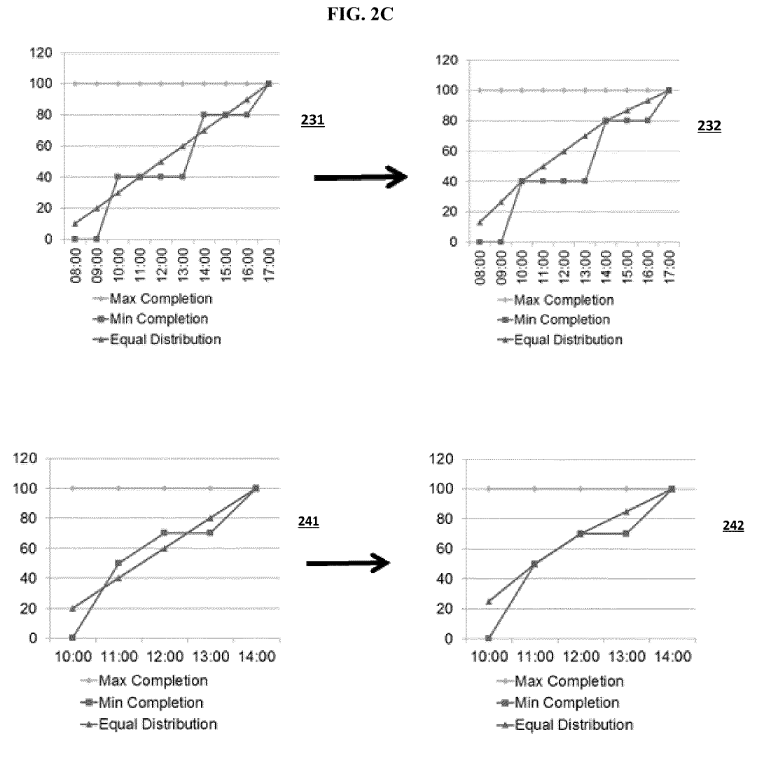

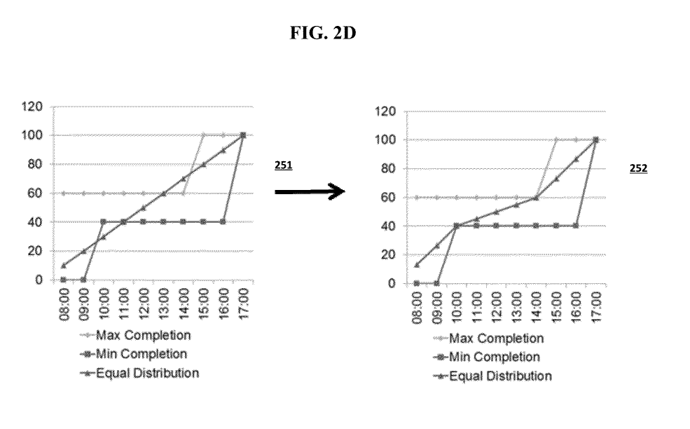

In an embodiment, when a workload is subject to both maximum and minimum constraints, an equal distribution plan might have to be adjusted in order to conform to the maximum and minimum constraints. Accordingly, a method of locally distributing the workload equally within the least number of time intervals would maintain an essentially equal distribution of the workload as whole while respecting the maximum and minimum constraints. FIG. 2A illustrates an embodiment of a method for conforming the equal distribution plan to the minimum and maximum constraints of the warehouse workload. In step 201, the complete planning time interval is retrieved (e.g., day). In step 202, the time interval is defined according to the earliest start and the latest end of the workloads. In step 203, the maximum value of the workload to be completed for the define time interval is retrieved (e.g., 80 kg). In step 204, the maximum and minimum constraints due to the earliest start and latest end are retrieved. In step 205, an equal distribution plan is calculated as a function of (1) the time interval and (2) the maximum workload value to be completed. As depicted in step 206, the equal distribution plan is calculated by dividing the max value of the workload by the length of the time interval (e.g., 80 kg/8 hours or 10 kg/hour). After the equal distribution plan is calculated in step 206, the method proceeds to check if either (or both) of the minimum or maximum constraints were violated by the equal distribution plan. In an embodiment, the maximum constraint is violated if the equal distribution plan exceeds the maximum constraint at a certain point in time (i.e., if a team attempts to complete more workloads of stock than there are available in the warehouse). Likewise, a minimum constraint is violated if the equal distribution plan goes below the minimum constraint at a certain point in time (i.e., a team does not complete the workload required by a certain due date). If there are no violations, in step 208, the method concludes and, therefore, the equal distribution plan does not need to be modified. Otherwise, if there is at least one violation, the method proceeds to step 209. In step 209, the maximum violation is determined. In an embodiment, if two maximum violations of equal value are determined, then only one is arbitrarily selected (the other maximum violation will be repaired in the next iteration of the method). In step 210, the maximum violation is determined by calculating the absolute value of the difference between the equal distribution plan and either the maximum or minimum constraint at the point of violation. Once the maximum point of violation is determined, in step 211, two new time intervals are defined using the point of the maximum violation, wherein the point is defined by the time of the violation as the x-coordinate and the value of the workload at either the minimum or maximum constraint (depending on which is violated) at the time of the violation as the y-coordinate. In other words, the maximum point of violation splits the previous time interval into two time intervals. After which, the method repeats steps 203 to 211 for each defined time interval until there are no more violations.

FIG. 2B illustrates an embodiment of an equal distribution plan defined within the minimum and maximum constraints of the warehouse workload. As depicted in graph 221 of FIG. 2B, the equal distribution plan does not violate either the maximum or minimum constraints. Accordingly, the equal distribution plan does not need to be modified. FIG. 2C, on the other hand, illustrates embodiments of (1) equal distribution plans in violation of the minimum and maximum constraints of the warehouse workload and (2) equal distribution plans conformed to the minimum and maximum constraints of the warehouse workload with the method of FIG. 2A. For example, as depicted in graph 231 of FIG. 2C, the equal distribution plan violates the minimum constraint at two points of the minimum constraint curve (i.e., at 10:00 and 14:00). Accordingly, using the method of FIG. 2A, three time intervals (i.e., 8:00-10:00, 10:00-14:00 and 14:00-17:00) were defined to get a fitting distribution in graph 232. Specifically, in the first iteration of the method, a maximum point of violation was determined (e.g., at (14:00, 80 kg)) and, subsequently, two new time intervals were defined (e.g., 8:00-14:00 and 14:00-17:00). In the following iteration of the method, for the time interval of 8:00-14:00, another maximum point of violation (e.g., at (10:00, 40 kg)) was determined; therefore two new time intervals (8:00-10:00 and 10:00-14:00) have to be defined at the maximum point of violation. However, there were no other violations of the maximum and minimum constraints for the time interval of 14:00-17:00; therefore the time interval did not need to be split any further. Accordingly, in the following iteration of the method, it is determined that the equal distribution plans for each of time intervals 8:00-10:00, 10:00-14:00 and 14:00-17:00 do not violate either the maximum or minimum constraints and therefore a fitting distribution for the workload is identified.

Similarly, as depicted in graph 241 of FIG. 2C, the equal distribution plan violates the minimum constraint at two points of the minimum constraint curve (i.e., at 11:00 and 12:00). Further, unlike the graph 231, the minimum constraint curve is parallel to the first equal distribution plan as it is being violated by the first equal distribution plan. Therefore, in an embodiment, an extreme value of the parallel line (i.e., the rightmost point) is used as the maximum point of violation in the first iteration method. Accordingly, using the method of FIG. 2A, five time intervals (i.e., 10:00-14:00; 10:00-12:00 and 12:00-14:00; and 10:00-11:00 and 11:00-12:00) were processed to get a fitting distribution corresponding to three time intervals (10:00-11:00; 11:00-12:00; and 12:00-14:00) in graph 242.

Further, with regard to graph 251 of FIG. 2D, the equal distribution plan violates both the minimum (at 10:00) and maximum (at 14:00) constraints. In an embodiment, the first maximum point of violation used for splitting the time interval is the one with the maximum distance to the equal distribution no matter if it violates the minimum or maximum constraint. Further, in an embodiment, if both the violations are of equal distance, then only one is arbitrarily selected (the other violation of equal distance will be repaired in the next iteration of the method). Accordingly, using the method of FIG. 2A, five time intervals (8:00-17:00; 8:00-14:00 and 14:00-17:00; 8:00-10:00 and 10:00-14:00) were processed to get a fitting distribution corresponding to three time intervals (8:00-10:00; 10:00-14:00; and 14:00-17:00) in graph 252 of FIG. 2D.

In an embodiment, an equal distribution plan can be further distributed subject to the corresponding warehouse areas assigned to the team. In an embodiment, the minimum constraint for the team level is defined by the sum of the minimum constraints of the area levels (the same applies for the maximum constraint of the team level). In an embodiment, a successful equal distribution plan at the team level is distributed to the warehouse area levels without violating the maximum and minimum constraints at the team level or the specific warehouse area levels. In an embodiment, the equal distribution plan at the team level is distributed equally to the specific warehouse levels. In another embodiment, the equal distribution plan at the team level is not distributed equally to the warehouse area levels but is instead distributed to the warehouse area levels subject to the minimum and maximum constraints of the warehouse area levels (i.e., the equal distribution plans for the individual warehouse area levels do not violate the maximum or minimum constraints of the warehouse area level).

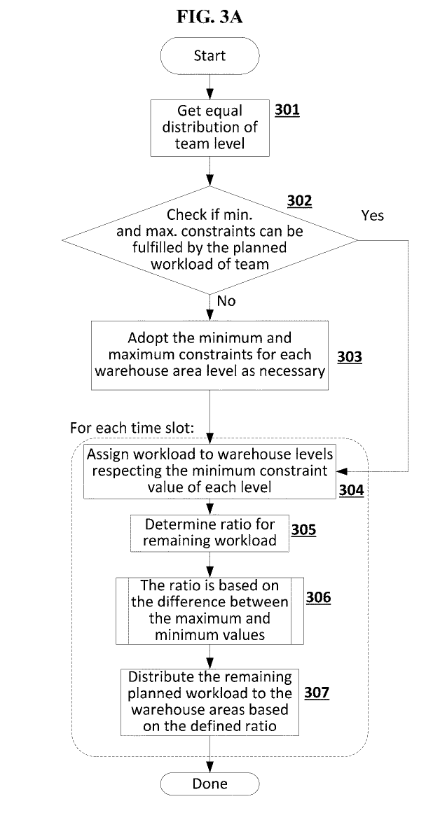

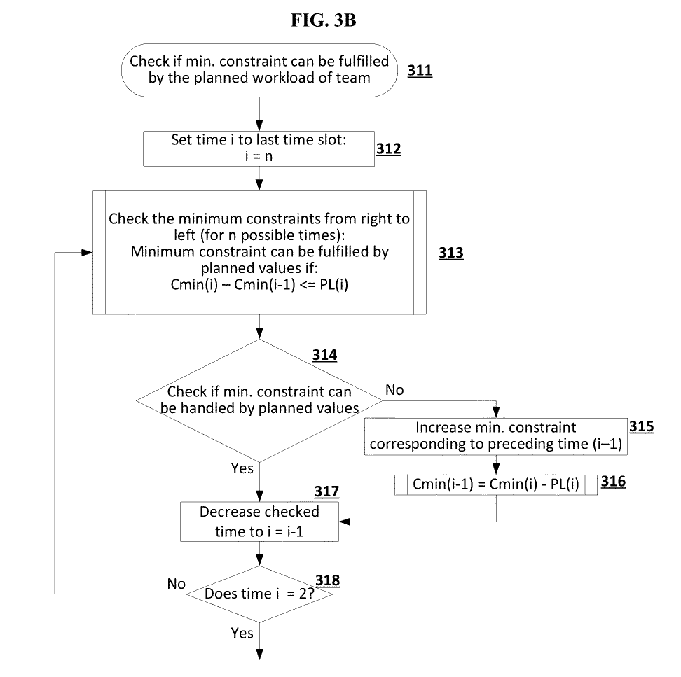

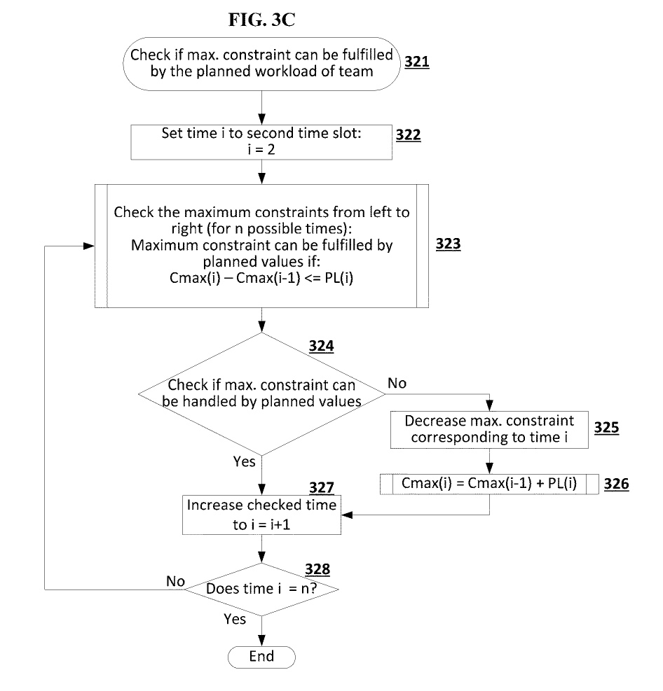

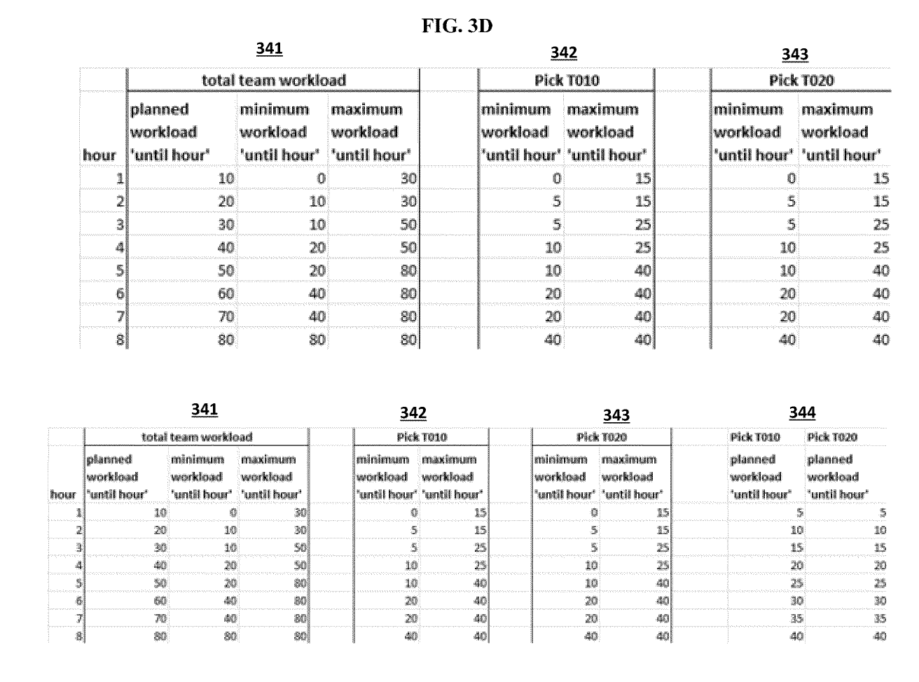

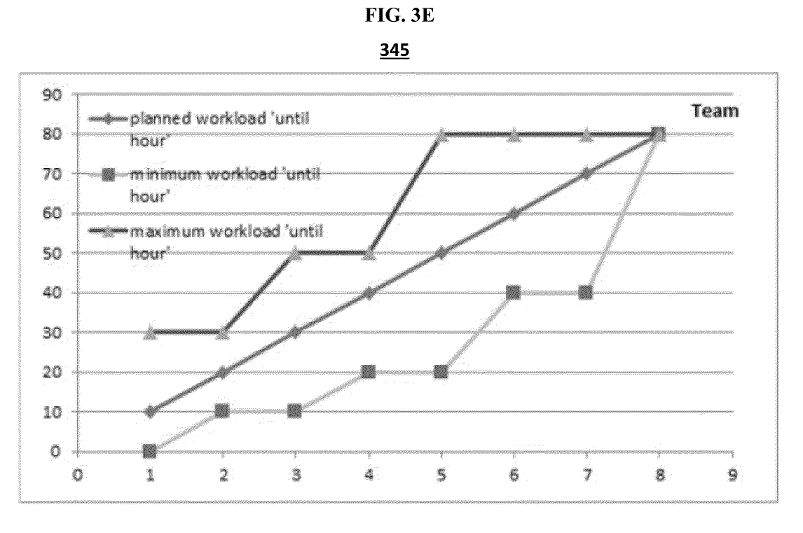

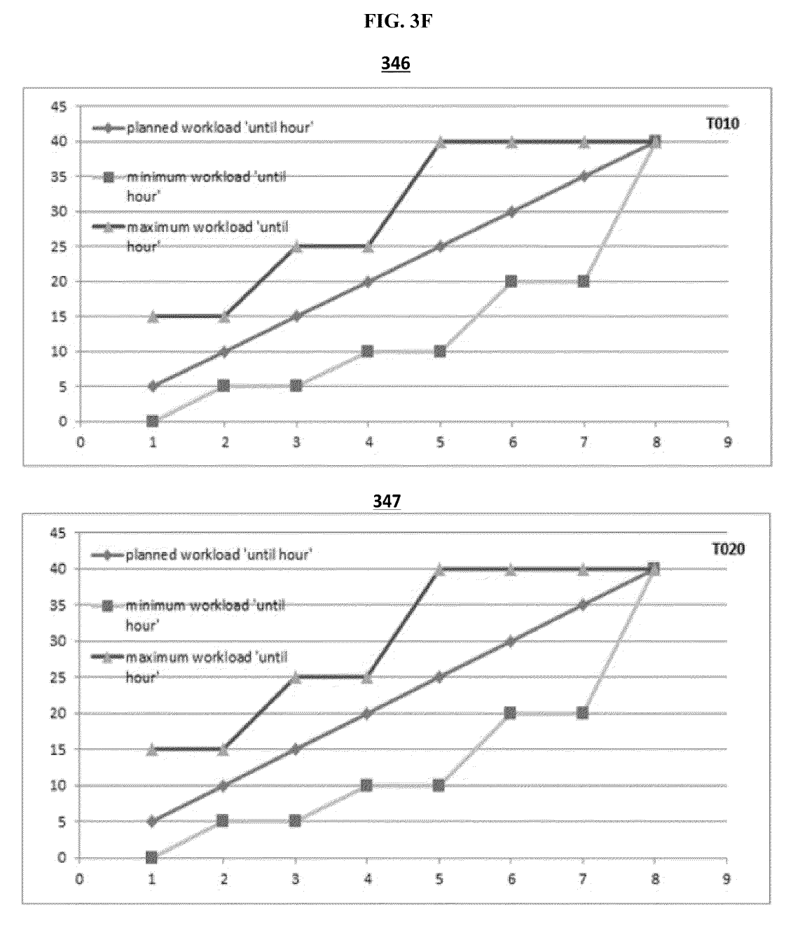

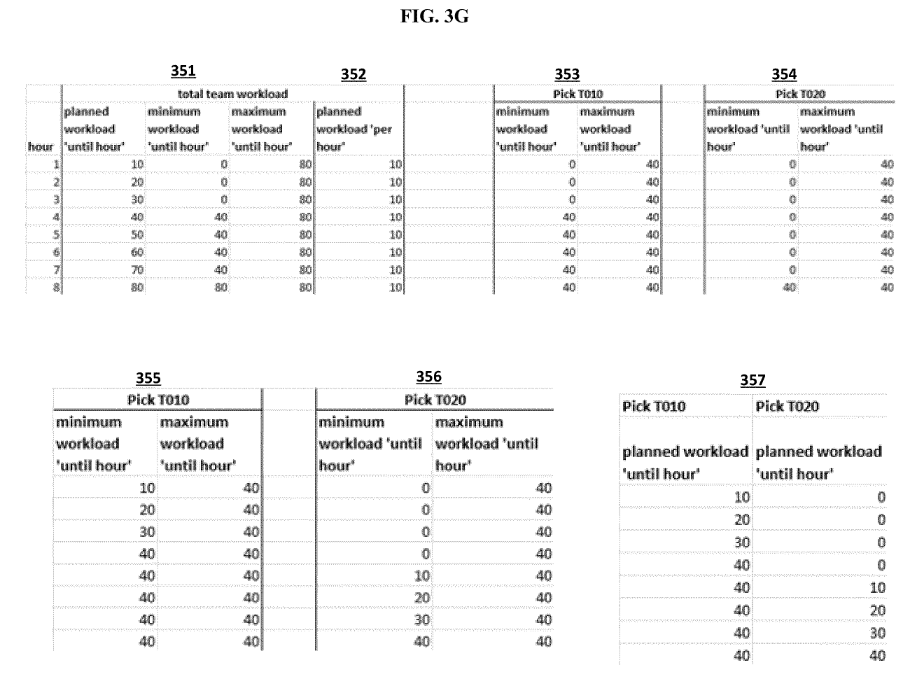

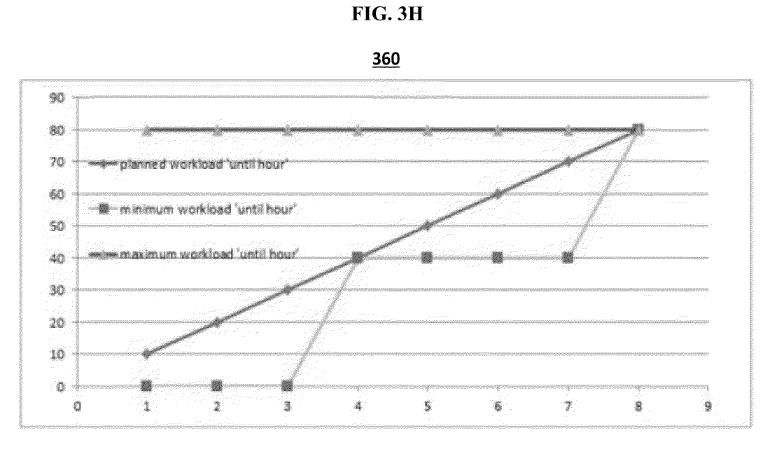

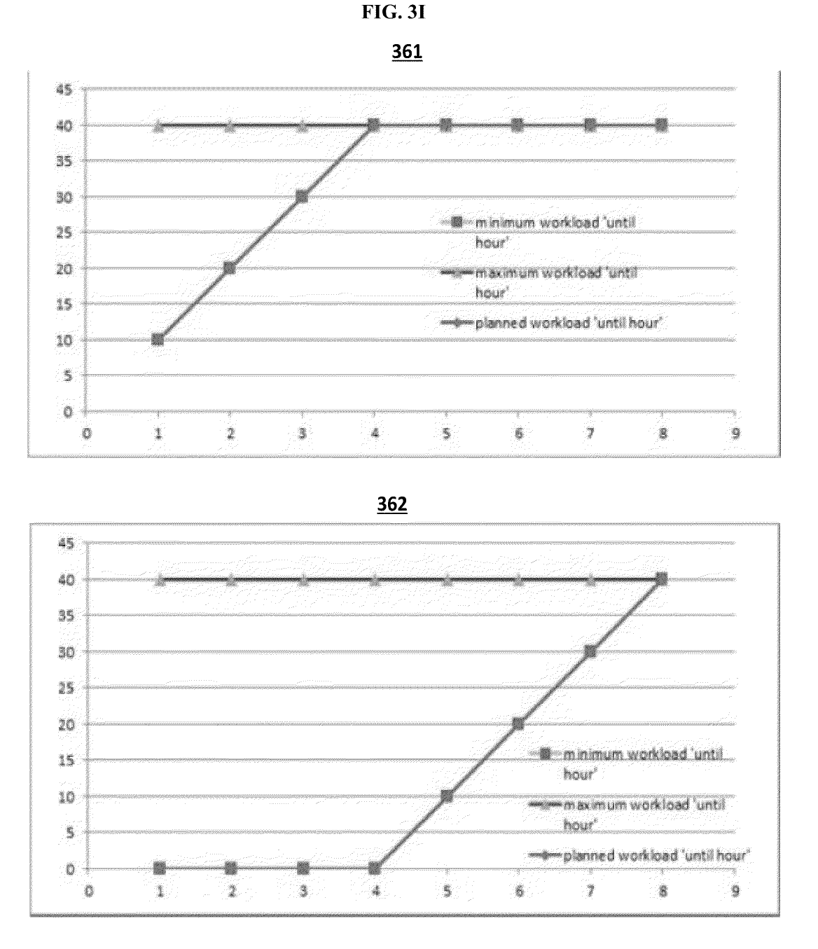

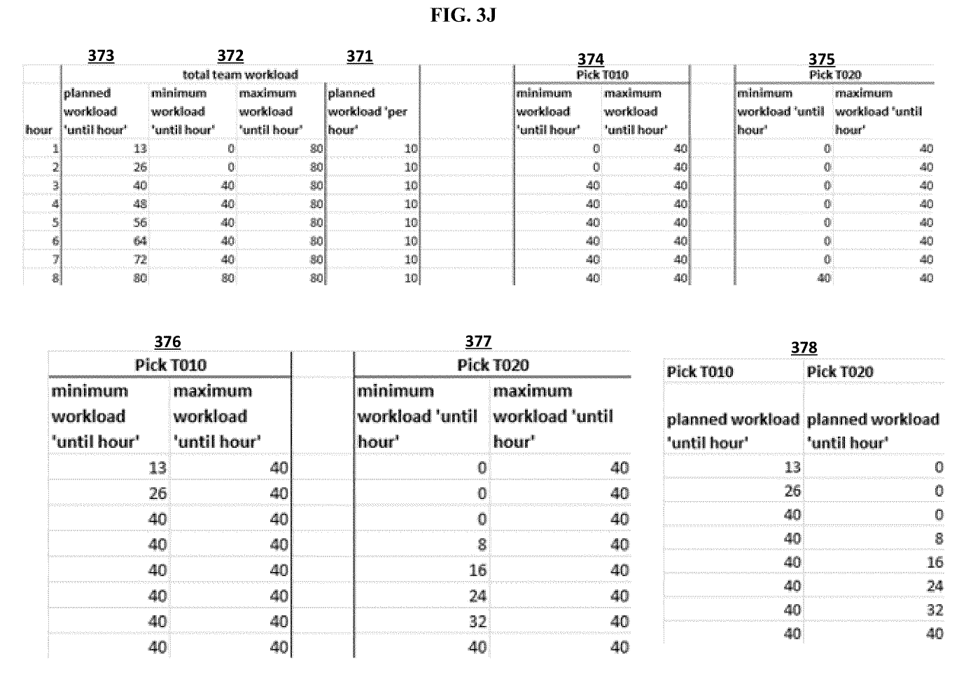

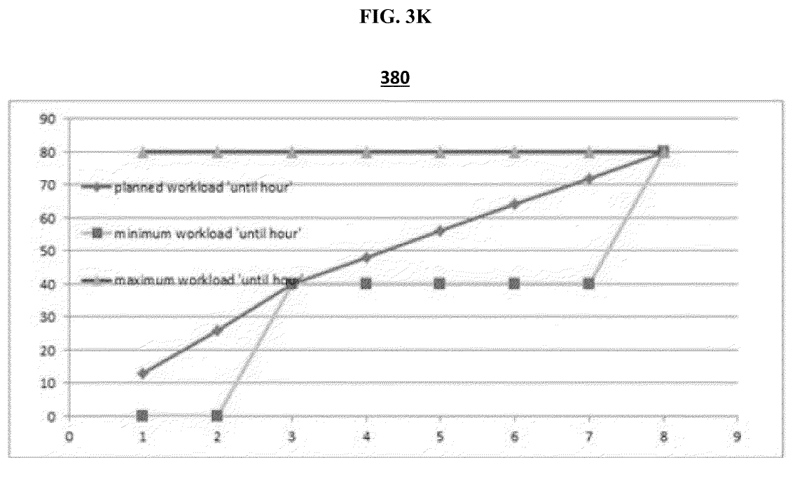

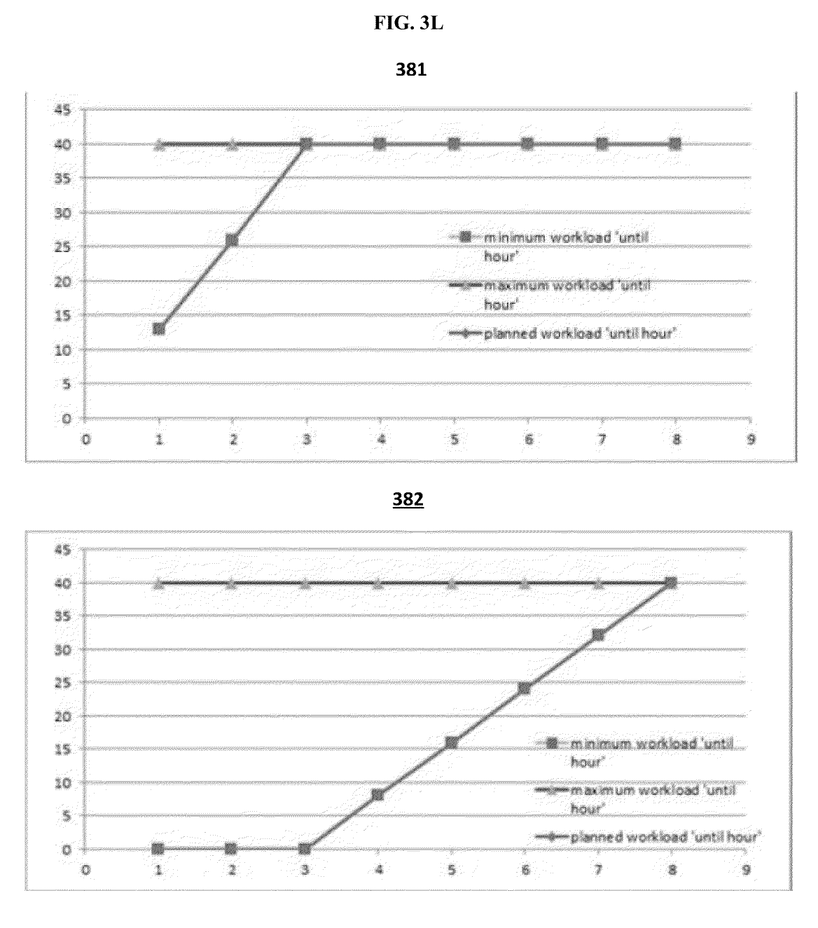

FIG. 3A illustrates an embodiment of a method for distributing a planned workload from a team level to the warehouse area levels. In step 301, the equal distribution plan of the team level is retrieved. Then, in step 302, it is checked if the minimum and maximum constraints of the individual warehouse area levels can be fulfilled by the equal distribution plan of the team level retrieved in step 301 (FIGS. 3B and 3C depict embodiments of methods used to check the minimum and maximum constraints, respectively). In step 303, the minimum and maximum constraints of the individual warehouse area levels are adopted for each individual warehouse area as required according to the check in step 302. For example, the minimum constraint is increased if the minimum constraint cannot fulfilled by the planned workload and the maximum constraint is decreased if the maximum constraint cannot be fulfilled by the planned workload). Otherwise, the method proceeds to step 304. In an embodiment, the following steps 304 to 307 are performed for each time slot of the workload (i.e., hours 1, 2, 3, 4, 5, 6, 7, and 8). In step 304, the workload of the equal distribution plan of the team level is assigned to each warehouse area subject to the values of the minimum constraint. In step 305, a ratio of the remaining workload between the warehouse area workloads is determined. In step 306, the ratio is determined based on the difference between the minimum and maximum values of the individual warehouse areas. Lastly, in step 307, the remaining workload is distributed to the warehouse areas based on the defined ratio.

FIG. 3B illustrates an embodiment of a method for determining whether the minimum constraint of a warehouse area level can be fulfilled by the equal distribution plan of the team level. Minimum constraint check 311 begins with step 312. In step 312, a variable n (signifying the last time slot of n possible time slots) is defined for a time i. In an embodiment, the algorithm for the minimum constraint check 311 is performed in step 313. In an embodiment, the algorithm is performed from the last time slot (i.e., time i=n) to the second time slot (i.e., time i=2). In other words, using a chronological time axis, the algorithm would be performed from right to left. In an embodiment, the minimum constraint of the warehouse areal level can be considered fulfilled by the equal distribution plan of the team level if:

Cmin(i)−Cmin(i−1)<PL(i);

where Cmin(i) is the minimum constraint of the warehouse area level at time i and PL(i) is the planned workload of the team level at time i. In step 314, it is determined if the minimum constraint can be handled by the equal distribution plan at the team level according to the algorithm in step 313. If it is determined that minimum constraint can be fulfilled by the equal distribution plan at the team level, then the method proceeds to step 317. However, if it is determined that minimum constraint cannot be fulfilled by the equal distribution plan at the team level, then the method proceeds to step 315. In step 315, the minimum constraint corresponding to the preceding time, i−1 (i.e., if i=8, then i−1=7; if i=7, then i−1=6, etc.), is increased. In an embodiment, the minimum constraint corresponding to time i−1 is increased according to the algorithm in step 316:

Cmin(i−1)=Cmin(i)−PL(i).

Accordingly, the minimum constraint of the preceding time slot, Cmin(i−1), adopts a new value (which will also be used in the further iterations of the algorithm). The method then proceeds to step 317. In step 317, the current time i is decreased by 1 (i.e., time slot goes from 8 to 7). Then, in step 318, it is determined if the current time i is equal to 2 (i.e., the second time slot). If the current time i does not equal to 2, then the algorithm loops back to step 313 with the value of the time slot calculated in step 317. Otherwise, if the current time i does equal to 2, then the method concludes.

FIG. 3C illustrates an embodiment of a method for determining whether the maximum constraint of a warehouse area level can be fulfilled by the equal distribution plan of the team level. Maximum constraint check 321 begins with step 322. In step 322, time i is defined as 2, (signifying the second time slot of n possible time slots). In an embodiment, the algorithm for the maximum constraint check 321 is performed in step 323. In an embodiment, the algorithm is performed from the second time slot (i.e., time i=2) to the last time slot (i.e., time i=n). In other words, using a chronological time axis, the algorithm would be performed from left to right. In an embodiment, the maximum constraint of the warehouse areal level can be considered fulfilled by the equal distribution plan of the team level if:

Cmax(i)−Cmax(i−1)<PL(i);

where Cmax(i) is the maximum constraint of the warehouse area level at time i and PL(i) is the planned workload of the team level at time i. In step 324, it is determined if the maximum constraint can be handled by the equal distribution plan at the team level according to the algorithm in step 323. If it is determined that maximum constraint can be fulfilled by the equal distribution plan at the team level, then the method proceeds to step 327. However, if it is determined that maximum constraint cannot be fulfilled by the equal distribution plan at the team level, then the method proceeds to step 325. In step 325, the maximum constraint corresponding to the current time, i, is decreased. In an embodiment, the maximum constraint corresponding to time i is increased according to the algorithm in step 326:

Cmax(i)=Cmax(i−1)+PL(i).

Accordingly, the maximum constraint of the current time slot, Cmax(i), adopts a new value (which will also be used in the further iterations of the algorithm). The method then proceeds to step 327. In step 327, the current time i is increased by 1 (i.e., time slot goes from 2 to 3). Then, in step 328, it is determined if the current time i is equal to n (i.e., the last time slot). If the current time i does not equal to n, then the algorithm loops back to step 323 with the value of the time slot calculated in step 327. Otherwise, if the current time i does equal to n, then the method concludes.

FIG. 3D illustrates an example of distributing a planned workload from a team level to the warehouse area levels utilizing the method of FIG. 3A. As depicted in FIG. 3D, there are two workload areas, T010 AND T020, assigned to the team. Table 341 (which also corresponds to graph 345 in FIG. 3E) depicts the equal distribution plan, the minimum workload constraint and the maximum workload constraint for the total team workload. Table 342 depicts the minimum and maximum workload constraints of warehouse area T010. Similarly, Table 343 depicts the minimum and maximum workload constraints of warehouse area T020. Applying the methods of FIGS. 3A, 3B AND 3C, a distribution plan for workload areas T010 and T020 is determined, the results of which are displayed in Table 344. Graphs 346 and 347 (of FIG. 3F) depict the equal distribution plans and minimum and maximum workload constraints for workload areas T010 and T020, respectively.

FIG. 3G illustrates another example of distributing a planned workload from a team level to the warehouse area levels utilizing the methods of FIGS. 3A, 3B and 3C. Similar to FIG. 3D, in FIG. 3G, there are two workload areas T010 and T020. Further, FIG. 3G also includes: Table 351 (corresponding to graph 360 in FIG. 3H), which depicts the equal distribution plan, the minimum workload constraint and the maximum workload constraint for the total team workload; Table 352, which depicts the planned workload for each hour of the equal distribution plan; Table 353, which depicts the minimum and maximum workload constraints of warehouse area T010; and Table 354, which depicts the minimum and maximum workload constraints of warehouse area T020. However, unlike FIG. 3D, the workload area T010 has to be finalized in the first half of the day (meaning the workload in workload area T020 can only commence in the second half of the day). Therefore, the maximum and minimum constraints for workload areas T010 and T020 were modified according to the methods of FIGS. 3B and 3C. The adopted values for the maximum and minimum constraints of workload areas T010 and T020 are depicted in Tables 355 and 356, respectively. As such, applying the method of FIG. 3A, the workload distribution plans for workload areas T010 and T020 is determined, the results of which are depicted in Table 357. Graphs 361 and 362 (of FIG. 3I) depict the workload distribution plans, minimum workload constraints and maximum workload constraints for workload areas T010 and T020, respectively.

FIG. 3J illustrates an example of distributing a planned workload from a team level to the warehouse area levels (with a violation of the minimum constraint) utilizing the methods of FIG. 3A, 3B AND 3C. As depicted by Table 371, which shows the initial planned workload for each hour of the equal distribution plan, and Table 372, which shows the minimum and maximum workload constraints for the total team workload, there is a violation of the minimum workload constraint at hour 3 (i.e., the sum of the workloads planned from hour 1 to hour 3 is 30, which is less than the minimum constraint of 40 at hour 3). Accordingly, applying the aforementioned method of FIG. 2A, a modified equal distribution plan is determined, which is represented by Table 373. The values of Tables 372 and 373 (i.e., minimum workload constraint, maximum workload constraint, and equal distribution plan, of the team level) are visually represented in graph 380 in FIG. 3K. Further, Table 374 depicts the minimum and maximum workload constraints of warehouse area T010; and Table 375 depicts the minimum and maximum workload constraints of warehouse area T020. Accordingly, applying the methods of FIGS. 3A, 3B AND 3C, adopted values for the minimum and maximum workload constraints for workload areas T010 AND T020 (which are depicted by Tables 376 and 377) as well as workload distribution plans for workload areas T010 and T020 (which is depicted by Table 378) are determined. Graphs 381 and 382 (of FIG. 3L) depict the workload distribution plans, minimum workload constraints and maximum workload constraints for workload areas T010 and T020, respectively.

In the foregoing examples, it was assumed that the total capacity of resources/employees was sufficient to fulfill the workload requirements, which is not always the case in real-world setting. Accordingly, in an embodiment, the equal distribution plan is also subject to the available capacity of resources and/or employees. Further, it was also assumed that it is possible to always fulfill all of the simultaneous workload constraints (i.e., (1) promised delivery dates, (2) the available stock (3) the available capacity. However, in a real-world setting, certain constraints have higher priority than others. In an embodiment, the priority depends on the possibility and/or costs to violate the constraint. For example, because it would be easier to involve unplanned employees on short notice due to fitting contracts, the delivery due date would have a higher priority to be fulfilled.

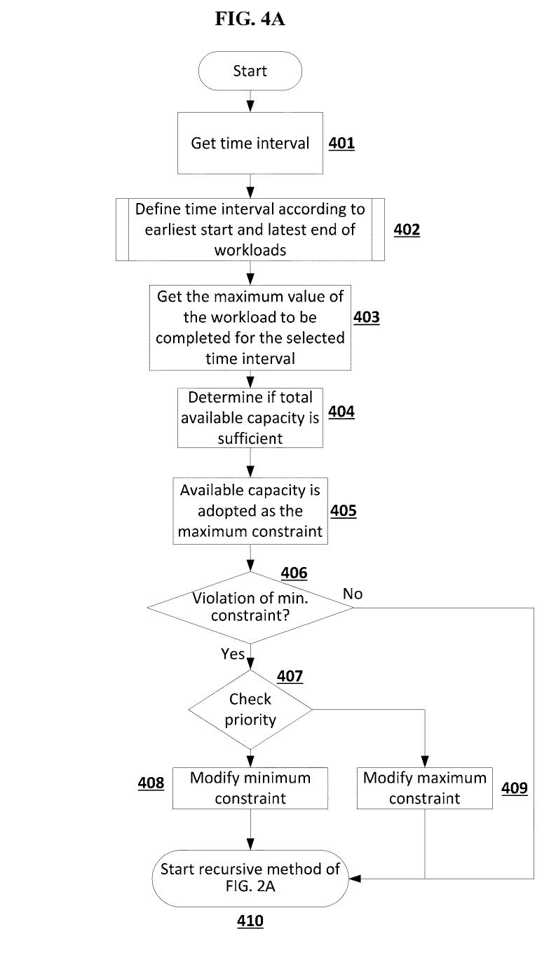

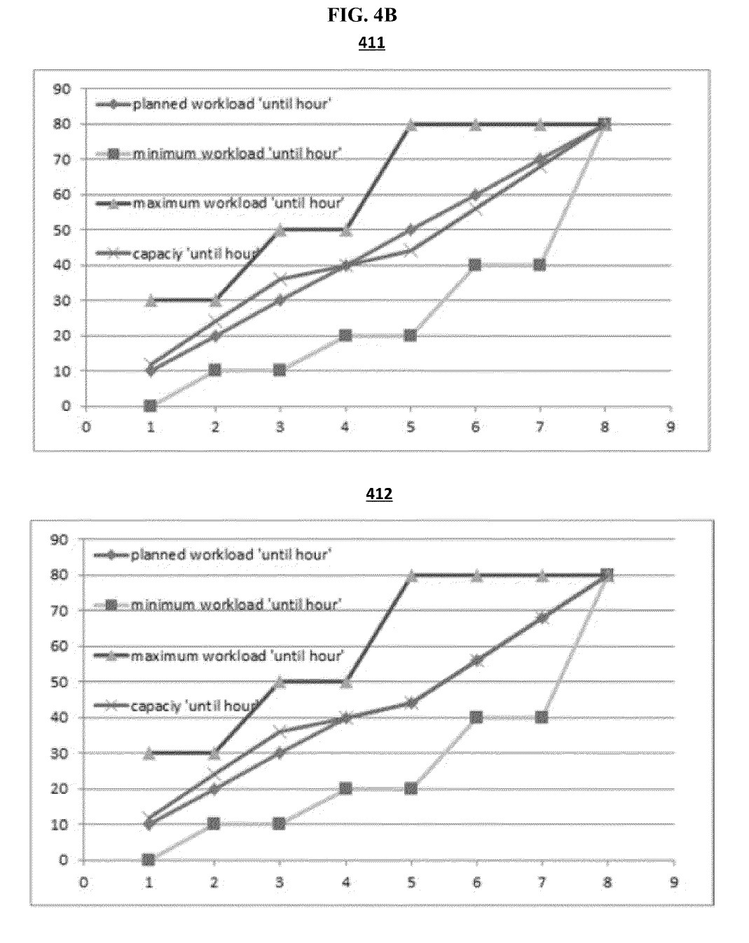

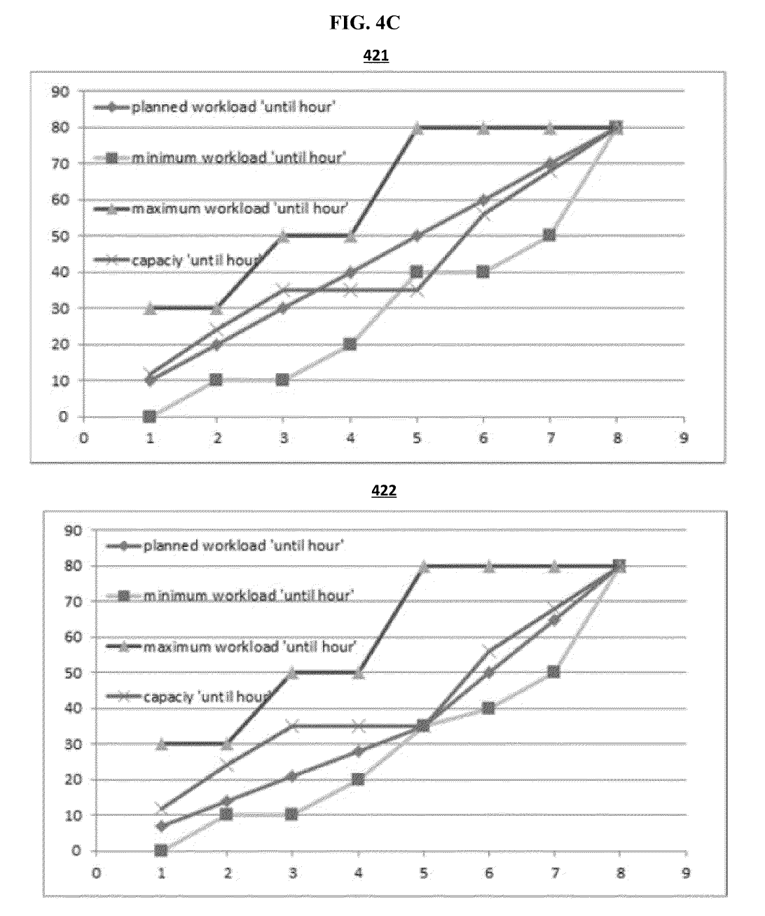

FIG. 4A illustrates an embodiment of a method for conforming the equal distribution plan to the available capacity of resources. In step 401, the complete planning time interval is retrieved (e.g., day). In step 402, the time interval is defined according to the earliest start and the latest end of the workloads. In step 403, the maximum value of the workload to be completed for the defined time interval is retrieved (e.g., 80 kg). In step 404, it is determined if the total available capacity is sufficient to fulfill the workload. In step 405, the available capacity is adopted as the maximum constraint. In step 406, is it is determined if adopting the available capacity as the maximum constraint would result in a violation of the minimum constraint (i.e., if the maximum constraint curve lies below the minimum constraint curve). Accordingly, if in step 406 it is determined that there was a violation of the minimum constraint, then the method proceeds to step 407. In step 407, the priority of the maximum and minimum constraints is checked. Therefore, if the maximum constraint has higher priority, the method proceeds to step 408 and the minimum constraint is modified to conform to the maximum constraint (i.e., minimum constraint curve is decreased). In other words, the available capacity is given a higher priority than the delivery date and thus the delivery date will not be fulfilled. Similarly, if the minimum constraint has higher priority, the maximum constraint is modified to conform to the minimum constraint (i.e., maximum constraint curve is increased). In other words, the delivery date is given a higher priority than the available capacity; and, thus, the available capacity may be insufficient on purpose. Accordingly, after either the minimum or maximum constraint is modified, the maximum constraint curve will remain higher or equal to the minimum constraint (thus, placing it in a condition to be processed by the method of FIG. 2A). Further, if there were no violations in step 406 or either one of the minimum constraint or maximum constraint was modified in steps 408 and 409, respectively, then the method proceeds to step 410. In step 410, the method of FIG. 2A is initiated with the above-discussed conditions.

FIG. 4B illustrates embodiments of (1) an equal distribution plan in violation of the available capacity and (2) an equal distribution plan conformed to the available capacity of the warehouse workload with the method of FIG. 4A. As depicted in graph 411 of FIG. 4B, the equal distribution plan violates the available capacity. Accordingly, applying the method of FIG. 4A, the equal distribution plan is conformed to the available capacity curve, as seen in graph 412. Therefore, because of the availability capacity, less workload is planned for hour 5.

FIG. 4C illustrates embodiments of (1) the available capacity in violation of the minimum constraint curve and (2) the equal distribution plan and minimum constraint curve conformed to the available capacity with the method of FIG. 4A. As depicted in graph 421 of FIG. 4C, the available capacity violates the minimum constraint curve at hour 5. Accordingly, applying the method of FIG. 4A and assuming that the available capacity has a higher priority than the minimum constraint, the equal distribution plan and the minimum constraint curve are conformed to the availability capacity, as seen in graph 422.

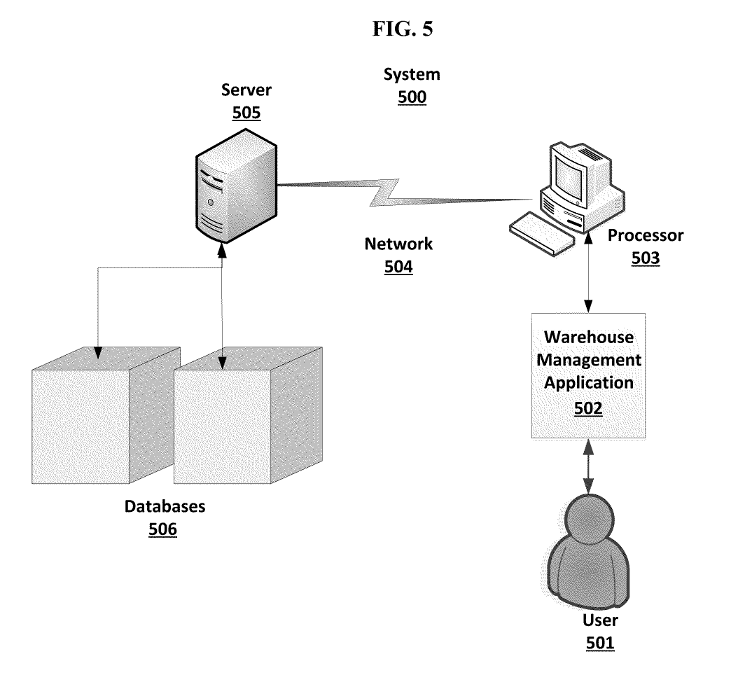

FIG. 5 illustrates an embodiment of a system utilizing the methods of the present invention. In an embodiment, the system 500 consists of a user 501, a warehouse management application 502, a processor 503 (with a display), a network 504, a server 505 and databases 506. In an embodiment, database 506 is an in-memory database. In an embodiment, database 506 is a database management system that employs a volatile storage. In an embodiment, database 506 is based on column store architecture, e.g., SAP® HANA Database provided by SAP SE. In an embodiment, database 506 includes an in-memory computing engine which comprises engines for column-based, row-based, and object-based in-memory or volatile storage as well as traditional nonvolatile storage. In an embodiment, these engines may be integrated in a way that, for example, data from row based storage can be directly combined with data from column based storage. In an embodiment, the aggregations and calculation of workload according to the methods of FIGS. 2A, 3A and 4A are performed by the in-memory computing engine in database 506.

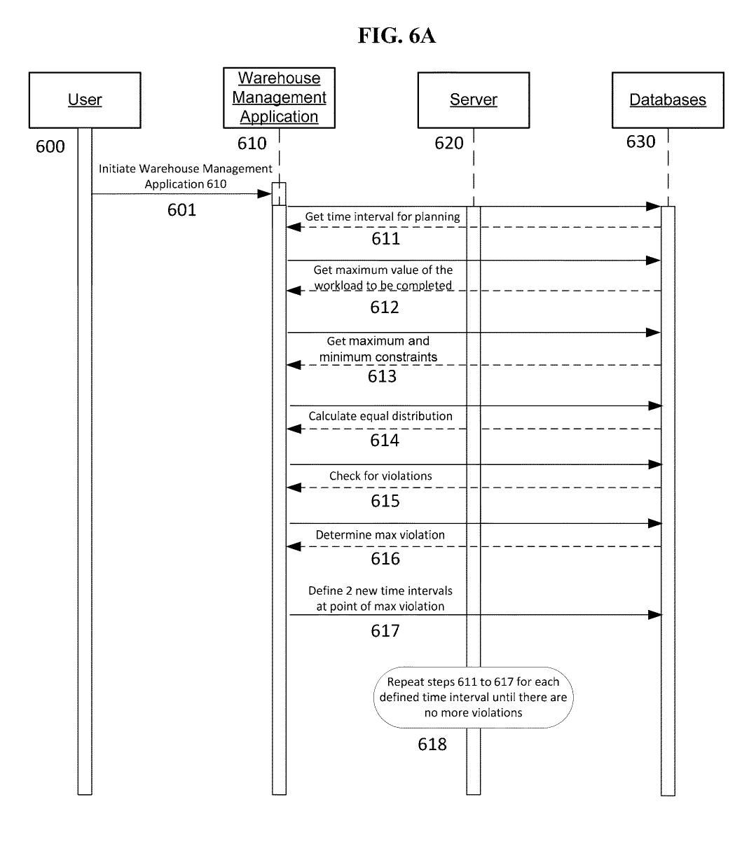

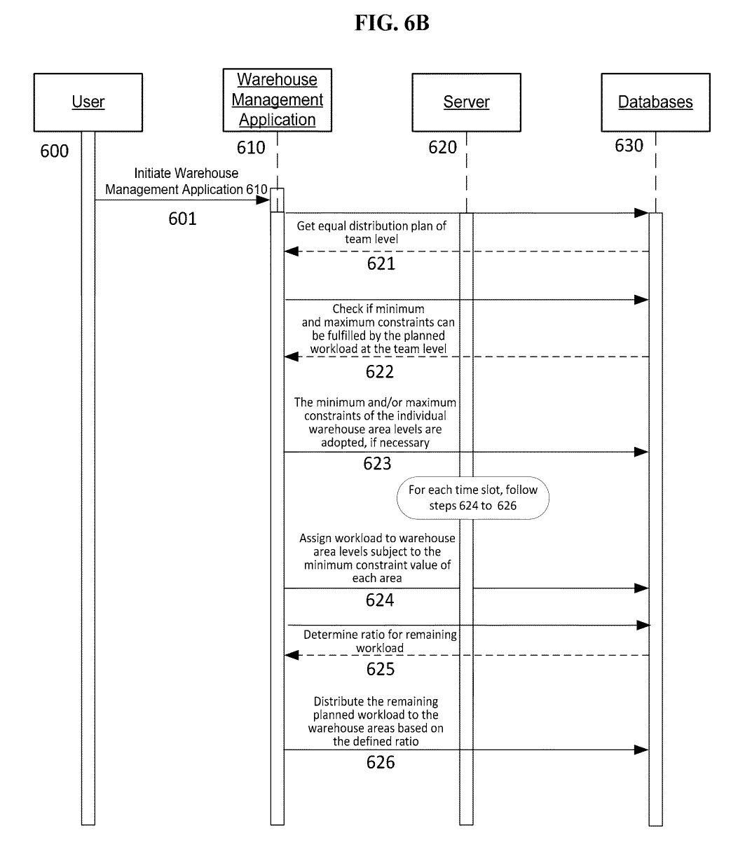

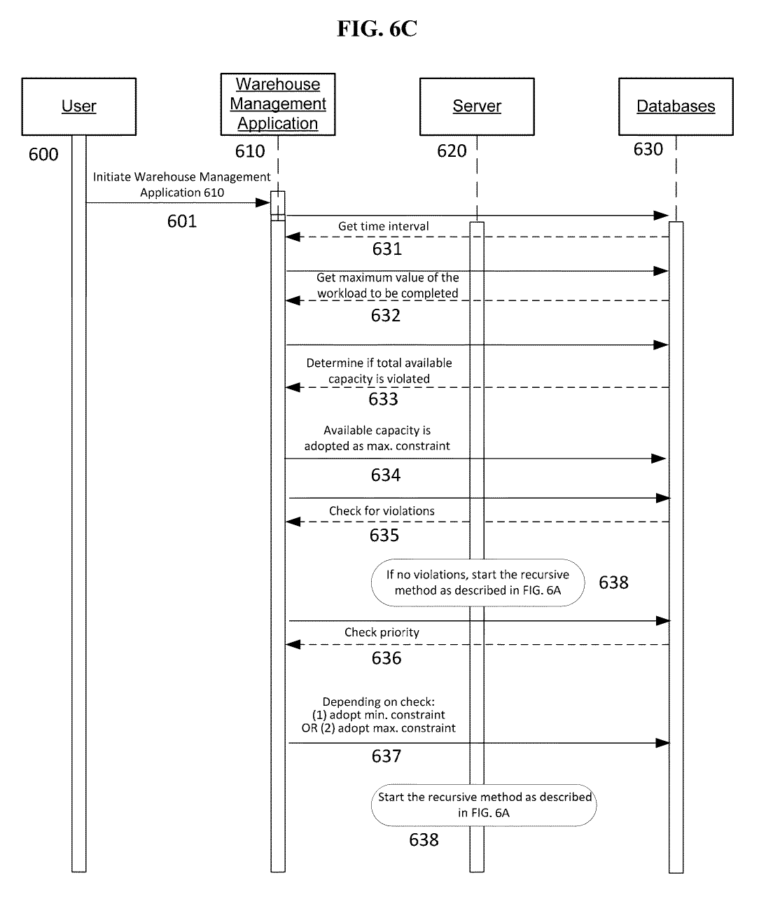

FIG. 6A illustrates an embodiment of the interaction between the elements of the system in order to conform the equal distribution plan to the minimum and maximum constraints of the warehouse workload. In step 601, the user 600 initiates the warehouse management application 610. In step 611, the warehouse management application 610 retrieves the time interval for planning from databases 630. In step 612, the warehouse management application 610 retrieves the maximum value of the workload to be completed for the defined time interval from databases 630. In step 613, the warehouse management application 610 retrieves the maximum and minimum constraints due to the earliest start and latest end from databases 630. In step 614, the warehouse management application 610 submits (1) the time interval and (2) the maximum value of the workload to be completed in order to calculate the equal distribution plan. In step 615, warehouse management application 610 checks for violations of the maximum and/or minimum constraints by the equal distribution plan. In step 616, the warehouse management application 610 determines the maximum violation of either (or both) of the minimum and maximum constraints by the equal distribution plan. In step 617, the warehouse management application 610 defines two new time intervals at the point of max violation. Lastly, in step 618, steps 611 to 617 are repeated for each defined time interval until there are no more violations of the minimum and maximum constraints.

FIG. 6B illustrates an embodiment of the interaction between the elements of the system in order to distribute a planned workload from a team level to the warehouse area levels. Similar to FIG. 6A, in step 601, the user 600 initiates the warehouse management application 610. In step 621, the warehouse management application 610 retrieves the equal distribution plan of the team level from the databases 630. In step 622, the warehouse management application 610 checks if the minimum and maximum constraints of the individual warehouse levels can be fulfilled by the equal distribution plan of the team level retrieved in step 621. In step 623, depending on the check, if either of the minimum or maximum constraints of the individual warehouse levels cannot be fulfilled by the equal distribution plan of the team level, then either the minimum or maximum constraints of the individual warehouse area levels is adopted. For example, the minimum constraint is increased if the minimum constraint cannot fulfilled by the planned workload and the maximum constraint is decreased if the maximum constraint cannot be fulfilled by the planned workload. The following steps 624 to 626 are performed for each time slot of the workload (i.e., hours 1, 2, 3, 4, 5, 6, 7, and 8). In step 624, the warehouse management application 610 assigns the workload of the equal distribution plan of the team level to each warehouse area subject to the values of the minimum constraint. In step 625, the warehouse management application 610 determines a ratio of the remaining workload between the warehouse area workloads. Lastly, in step 626, the warehouse management application 610 distributes the remaining workload to the warehouse areas based on the defined ratio.

FIG. 6C illustrates an embodiment of the interaction between the elements of the system in order to conform the equal distribution plan to the available capacity of resources. Similar to FIG. 6A, in step 601, the user 600 initiates the warehouse management application 610. In step 631, the warehouse management application 610 retrieves the time interval for planning from databases 630. In step 632, the warehouse management application 610 retrieves the maximum value of the workload to be completed for the defined time interval from databases 630. In step 633, the warehouse management application 610 checks if the total available capacity is sufficient to fulfill the workload. In step 634, the warehouse management application 610 adopts the available capacity as the maximum constraint. In step 635, the warehouse management application 610 checks if adopting the available capacity as the maximum constraint would result in a violation of the minimum constraint. In step 636, if it is determined that there was a violation of the minimum constraint, the warehouse management application 610 then checks the priority of the maximum and minimum constraints. In step 637, depending on the check, the warehouse management application 610 adopts either the minimum constraint or the maximum constraint. Lastly, if there were no violations in step 635 or either one of the minimum constraint or maximum constraint was modified in steps 637, then the warehouse management application 610 proceeds to the recursive method described in FIG. 6A.

Implementations of the various techniques described herein may be implemented in digital electronic circuitry, or in computer hardware, firmware, software, or in combinations of them. Implementations may be implemented as a computer program product, i.e., a computer program tangibly embodied in an information carrier, e.g., in a machine-readable storage device or in a propagated signal, for execution by, or to control the operation of, data processing apparatus, e.g., a programmable processor, a computer, or multiple computers. A computer program, such as the computer program(s) described above, can be written in any form of programming language, including compiled or interpreted languages, and can be deployed in any form, including as a stand-alone program or as a module, component, subroutine, or other unit suitable for use in a computing environment. A computer program can be deployed to be executed on one computer or on multiple computers at one site or distributed across multiple sites and interconnected by a communication network.

Method steps may be performed by one or more programmable processors executing a computer program to perform functions by operating on input data and generating output. Method steps also may be performed by, and an apparatus may be implemented as, special purpose logic circuitry, e.g., an FPGA (field programmable gate array) or an ASIC (application-specific integrated circuit).

Processors suitable for the execution of a computer program include, by way of example, both general and special purpose microprocessors, and any one or more processors of any kind of digital computer. Generally, a processor will receive instructions and data from a read-only memory or a random access memory or both. Elements of a computer may include at least one processor for executing instructions and one or more memory devices for storing instructions and data. Generally, a computer also may include, or be operatively coupled to receive data from or transfer data to, or both, one or more mass storage devices for storing data, e.g., magnetic, magneto-optical disks, or optical disks. Information carriers suitable for embodying computer program instructions and data include all forms of non-volatile memory, including by way of example semiconductor memory devices, e.g., EPROM, EEPROM, and flash memory devices; magnetic disks, e.g., internal hard disks or removable disks; magneto-optical disks; and CD-ROM and DVD-ROM disks. The processor and the memory may be supplemented by, or incorporated in special purpose logic circuitry.

To provide for interaction with a user, implementations may be implemented on a computer having a display device, e.g., a cathode ray tube (CRT), liquid crystal display (LCD) monitor, or an optical head-mounted display (OHMD), for displaying information to the user and a keyboard and a pointing device, e.g., a mouse or a trackball, by which the user can provide input to the computer. Other kinds of devices can be used to provide for interaction with a user as well; for example, feedback provided to the user can be any form of sensory feedback, e.g., visual feedback, auditory feedback, or tactile feedback; and input from the user can be received in any form, including acoustic, speech, or tactile input.

Implementations may be implemented in a computing system that includes a back-end component, e.g., as a data server, or that includes a middleware component, e.g., an application server, or that includes a front-end component, e.g., a client computer having a graphical user interface or a Web browser through which a user can interact with an implementation, or any combination of such back-end, middleware, or front-end components. Components may be interconnected by any form or medium of digital data communication, e.g., a communication network. Examples of communication networks include a local area network (LAN) and a wide area network (WAN), e.g., the Internet.

Although the foregoing invention has been described in some detail for purposes of clarity of understanding, it will be apparent that certain changes and modifications can be practiced within the scope of the appended claims. The described embodiment features can be used with and without each other to provide additional embodiments of the present invention. The present invention can be practiced according to the claims without some or all of these specific details. For the purpose of clarity, technical material that is known in the technical fields related to the invention has not been described in detail so that the present invention is not unnecessarily obscured. It should be noted that there are many alternative ways of implementing both the process and apparatus of the present invention. Accordingly, the present embodiments are to be considered as illustrative and not restrictive, and the invention is not to be limited to the details given herein, but can be modified within the scope and equivalents of the appended claims.

What is claimed is:

1. A computer-implemented method for equally distributing workloads in a warehouse, the method comprising:
retrieving from a database, with a processor, (1) a time interval for planning a workload distribution for a warehouse team, (2) a maximum value of the workload to be completed, (3) a minimum and maximum constraint of the workload distribution;
calculating, with the processor, an equal workload distribution plan as a function of (1) the time interval for planning the workload distribution and (2) the maximum value of the workload to be completed;
determining, with the processor, any violations of at least one of the minimum and maximum constraints by the equal workload distribution;
splitting, with the processor, the time interval into two new time intervals based on the point of violation of at least one of the minimum and maximum constraints by the equal workload distribution;
repeating the calculating, determining and splitting step for each split time interval until there are no more violations of at least one of the minimum and maximum constraints by the equal workload distribution; and
determining, with the processor, a workload distribution plan wherein the workload is locally distributed equally within a least number of time intervals of the time interval for planning the workload distribution.

2. The method of claim 1, further comprising:
retrieving from the database, with a processor, minimum and maximum constraints of each of at least two warehouse areas assigned to the warehouse team;
checking, with the processor, when at least one of the minimum and maximum constraints of each of the at least two warehouse areas assigned to the warehouse team can be fulfilled by the workload distribution plan, and
wherein for each time slot of the time interval for planning the workload distribution:
assigning, with the processor, the workload from the workload distribution plan to each of the at least two warehouse areas, wherein the assigned workload is subject to the minimum constraint of a respective warehouse area of the at least two warehouse area;
determining, with the processor, a ratio of a remaining workload; and
distributing, with the processor, the remaining workload among the at least two warehouse areas based on the determined ratio.

3. The method of claim 1, wherein the minimum constraint represents the promised delivery date of some of the workload and the maximum constraint represents one of (1) available stock and (2) available capacity of at least one of resources or employees.

4. The method of claim 3, wherein a first priority is assigned to the maximum constraint and a second priority is assigned to the minimum constraint.

5. The method of claim 4, wherein, depending on the first and second priority, one of the maximum or minimum constraints is ignored.

6. The method of claim 1, wherein the determined point of violation is a point in time representing the greatest difference between at least one of a minimum or maximum constraints and the equal workload distribution plan, wherein, for the violation of the maximum constraint, the equal distribution workload distribution plan exceeds the maximum constraint and, wherein, for the violation of the minimum constraint, the minimum constraint exceeds the equal workload distribution plan.

7. The method of claim 2, wherein the minimum constraint represents the promised delivery date of some of the workload and the maximum constraint represents one of (1) available stock and (2) available capacity of at least one of resources or employees.

8. A non-transitory computer readable medium containing program instructions for equally distributing workloads in a warehouse, wherein execution of the program instructions by one or more processors of a computer system causes one or more processors to carry out the steps of:
retrieving from a database (1) a time interval for planning a workload distribution for a warehouse team, (2) a maximum value of the workload to be completed, (3) a minimum and maximum constraint of the workload distribution;
calculating an equal workload distribution plan as a function of (1) the time interval for planning the workload distribution and (2) the maximum value of the workload to be completed;
determining any violations of at least one of the minimum and maximum constraints by the equal workload distribution;
splitting the time interval into two new time intervals based on the point of violation of at least one of the minimum and maximum constraints by the equal workload distribution;
repeating the calculating, determining and splitting step for each split time interval until there are no more violations of at least one of the minimum and maximum constraints by the equal workload distribution; and
determining a workload distribution plan wherein the workload is locally distributed equally within a least number of time intervals of the time interval for planning the workload distribution.

9. The non-transitory computer readable medium of claim 8, further comprising:
retrieving from the database minimum and maximum constraints of each of at least two warehouse areas assigned to the warehouse team;
checking when at least one of the minimum and maximum constraints of each of the at least two warehouse areas assigned to the warehouse team can be fulfilled by the workload distribution plan, and
wherein for each time slot of the time interval for planning the workload distribution:
assigning the workload from the workload distribution plan to each of the at least two warehouse areas, wherein the assigned workload is subject to the minimum constraint of a respective warehouse area of the at least two warehouse area;
determining a ratio of a remaining workload; and
distributing the remaining workload among the at least two warehouse areas based on the determined ratio.

10. The non-transitory computer readable medium of claim 8, wherein the minimum constraint represents the promised delivery date of some of the workload and the maximum constraint represents one of (1) available stock and (2) available capacity of at least one of resources or employees.

11. The non-transitory computer readable medium of claim 10, wherein a first priority is assigned to the maximum constraint and a second priority is assigned to the minimum constraint.

12. The non-transitory computer readable medium of claim 11, wherein, depending on the first and second priority, one of the maximum or minimum constraints is ignored.

13. The non-transitory computer readable medium of claim 8, wherein the determined point of violation is a point in time representing the greatest difference between at least one of a minimum or maximum constraints and the equal workload distribution plan, wherein, for the violation of the maximum constraint, the equal distribution workload distribution plan exceeds the maximum constraint and, wherein, for the violation of the minimum constraint, the minimum constraint exceeds the equal workload distribution plan.

14. The non-transitory computer readable medium of claim 9, wherein the minimum constraint represents the promised delivery date of some of the workload and the maximum constraint represents one of (1) available stock and (2) available capacity of at least one of resources or employees.

15. A system directed to creating target values with a first graphical user interface application on a cloud-based system, comprising of:
a database;
a processor, wherein the processor is configured to perform the steps of:
retrieving from a database (1) a time interval for planning a workload distribution for a warehouse team, (2) a maximum value of the workload to be completed, (3) a minimum and maximum constraint of the workload distribution;
calculating an equal workload distribution plan as a function of (1) the time interval for planning the workload distribution and (2) the maximum value of the workload to be completed;
determining any violations of at least one of the minimum and maximum constraints by the equal workload distribution;
splitting the time interval into two new time intervals based on the point of violation of at least one of the minimum and maximum constraints by the equal workload distribution;
repeating the calculating, determining and splitting step for each split time interval until there are no more violations of at least one of the minimum and maximum constraints by the equal workload distribution; and
determining a workload distribution plan wherein the workload is locally distributed equally within a least number of time intervals of the time interval for planning the workload distribution.

16. The system of claim 15, wherein the processor is configured to further perform the steps of:
retrieving from the database minimum and maximum constraints of each of at least two warehouse areas assigned to the warehouse team;
checking when at least one of the minimum and maximum constraints of each of the at least two warehouse areas assigned to the warehouse team can be fulfilled by the workload distribution plan, and
wherein for each time slot of the time interval for planning the workload distribution:
assigning the workload from the workload distribution plan to each of the at least two warehouse areas, wherein the assigned workload is subject to the minimum constraint of a respective warehouse area of the at least two warehouse area;
determining a ratio of a remaining workload; and
distributing the remaining workload among the at least two warehouse areas based on the determined ratio.

17. The system of claim 15, wherein the minimum constraint represents the promised delivery date of some of the workload and the maximum constraint represents one of (1) available stock and (2) available capacity of at least one of resources or employees.

18. The system of claim 17, wherein a first priority is assigned to the maximum constraint and a second priority is assigned to the minimum constraint.

19. The system of claim 18, wherein, depending on the first and second priority, one of the maximum or minimum constraints is ignored.

20. The system of claim 15, wherein the database is an in-memory database.
